(19) United States
(12) Patent Application Publication
(10) Pub. No.: US 2013/0235965 A1
(43) Pub. Date: Sep. 12, 2013

(54) Apparatus For Testing Loss-Of-Coolant Accident Using Model Of Nuclear Containment Building

(71) Applicants: Byung-Chul Lee, Seoul (KR); Chan-Kuk Moon, Daejeon-si (KR); Hyeong-Taek Kim, Daejeon-si (KR); Sang-Won Lee, Daejeon-si (KR); Yu-Jeong Choi, Daejeon-si (KR); Tae-Hyeop Hong, Daejeon-si (KR)

(72) Inventors: Byung-Chul Lee, Seoul (KR); Chan-Kuk Moon, Daejeon-si (KR); Hyeong-Taek Kim, Daejeon-si (KR); Sang-Won Lee, Daejeon-si (KR); Yu-Jeong Choi, Daejeon-si (KR); Tae-Hyeop Hong, Daejeon-si (KR)

(73) Assignee: FNC TECHNOLOGY CO., LTD., Seoul (KR)

(21) Appl. No.: 13/495,343

(22) Filed: Jun. 13, 2012

(30) Foreign Application Priority Data
Mar. 6, 2012 (KR) 10-2012-00022989

(51) Int. Cl. G21C 17/00

(52) U.S. Cl. 376/246

(57) ABSTRACT

Provided is an apparatus for testing a loss-of-coolant accident using a model of a nuclear containment building, including a containment vessel of which an upper surface is opened and side and lower surfaces are transparent; an internal structure which is disposed in the containment vessel; a hose pipe which is disposed at an upper side of the containment vessel; and a measuring device which is disposed at the lower surface of the containment vessel so as to monitor movement of fluid and debris in the containment vessel.

### CROSS-REFERENCE TO RELATED APPLICATIONS

The present invention claims priority of Korean Patent Application No. 10-2012-0022989, filed on Mar. 6, 2012, which is incorporated herein by reference.

### FIELD

The present invention relates to an apparatus for testing a loss-of-coolant accident using a model of a nuclear containment building.

### BACKGROUND

Generally, safety equipment for nuclear power plants is designed in consideration of a design basis accident such as a loss-of-coolant accident. In case that a control rod is not operated or the accident cannot be solved with only the control rod, an ECCS (Emergency Core Cooling System) in a nuclear reactor is operated. Herein, water stored in a RWST (Refueling Water Storing Tank) is used as a source of water supply of a spray pump so as to cool the nuclear reactor. If the water in the RWST is exhausted, it is converted into a recirculation operating mode using a recirculation sump so as to continuously circulate the coolant. To this end, the ECCS includes a recirculation pump, a strainer, a recirculation sump and the like.

However, even though the ECCS is operated, a main pipe may be broken upon the loss-of-coolant accident (LOCA), and thus debris including a material forming the pipe, a heat insulation material and other materials may be generated due to non-chemical and chemical reactions in a containment vessel. The debris may obstruct a fluid passage for the recirculation cooling and thus the cooling process may not perform smoothly. That is, the debris may be transported to the bottom of a nuclear reactor building, and the recirculation may be prevented or clogging may occur at a filtering screen. Further, if the debris is excessively accumulated at a certain place, the pump may be damaged.

FIG. 1 shows the LOCA situation. Herein, the pipe in the primary containment vessel is damaged, the coolant is flowed to the bottom of the containment vessel, the RWST is operated, and the coolant passing through the strainer and collected in the water container is used again. If the clogging has occurred at the strainer due to the debris, the pump is overloaded and the recirculation cooling may not perform smoothly.

Distribution and transport ratio of the debris may be changed according to the damaged position and an influence of the debris may be also changed. It is necessary to analyze an influence exerted on head loss in consideration of various factors such as transport of the debris, chemical interaction in the flowing at a front side of the strainer, generation and decomposition of chemical particles in recirculated water, and head loss. However, information about the distribution, transport speed and transport rate of the debris is not actually provided.

In Korean Patent Application No.10-2008-0064121, there is disclosed a monitoring method for calculating an unidentified leak rate of a reactor coolant system by using a kalman filter or kalman smoother. However, in the monitoring method, the leak rate is just provided as a numerical value, and the actual information about the distribution, transport speed and transport rate of the debris generated by a pipe breaking accident is not provided.

### SUMMARY

An embodiment of the present invention is directed to providing an apparatus for testing a loss-of-coolant accident using a model of a nuclear containment building, which can visually provide information about a flow rate upon LOCA, distribution of debris and the like.

To achieve the object of the present invention, the present invention provides an apparatus for testing a loss-of-coolant accident using a model of a nuclear containment building, including a containment vessel of which an upper surface is opened and side and lower surfaces are transparent; an internal structure which is disposed in the containment vessel; a hose pipe which is disposed at an upper side of the containment vessel; and a measuring device which is disposed at the lower surface of the containment vessel so as to monitor movement of fluid and debris in the containment vessel.

In an embodiment, preferably, a water container part is disposed at the lower surface of the containment vessel and connected with the hose pipe.

In an embodiment, preferably, the hose pipe is movable in all directions.

In an embodiment, preferably, the hose pipe further includes a heater for heating injected fluid, and a debris storing part for injecting non-chemical and chemical debris generated upon an actual accident.

### DRAWINGS

FIG. 1 is a view showing a state of a loss-of-coolant accident (LOCA).

FIGS. 2 and 3 are views showing a test apparatus according to the present invention.

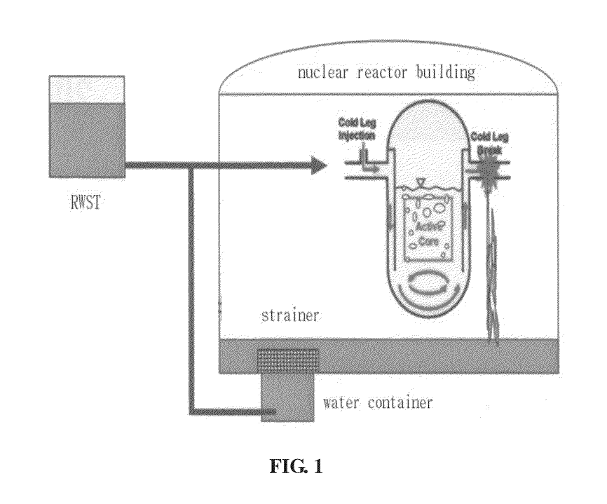

Detailed Description of Main Elements

| | |
|---|---|
| 11: hose pipe | 12: containment vessel |
| 13: internal structure | 14: side surface |
| 15: water container part | 16: measuring device |
| 17: lower surface | |

### DETAILED DESCRIPTION

Hereinafter, the embodiments of the present invention will be described in detail with reference to accompanying drawings.

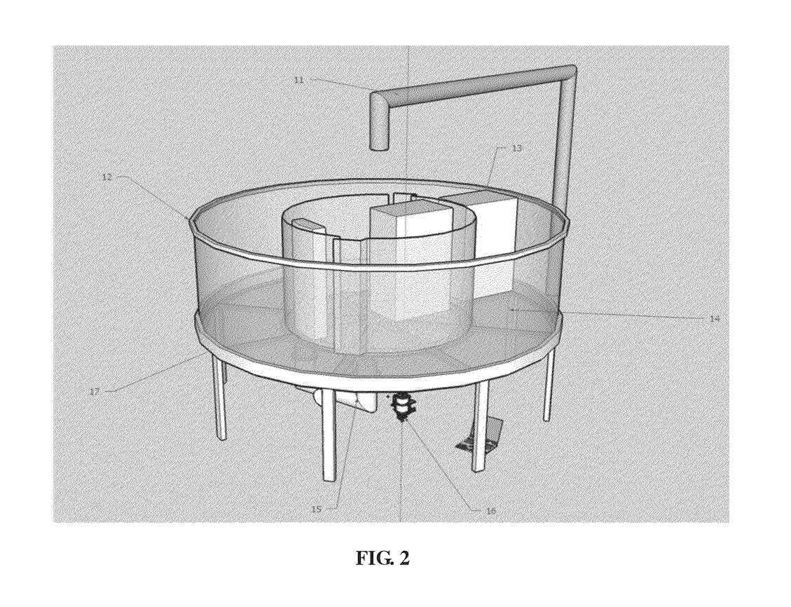

FIG. 2 shows a model of a containment vessel according to the present invention. A containment vessel 12 which miniaturizes a containment vessel of an actual nuclear reactor is provided as the model of the containment vessel. An internal structure 13 which miniaturizes an internal structure of the actual nuclear reactor is disposed in the containment vessel 12. The containment vessel 12 and the internal structure 13 may be changed according to the nuclear reactor.

A hose pipe 11 is formed at an upper side of the containment vessel 12 so as to be moved in all directions. Because the configuration for moving the hose pipe 11 can be embodied with well-known technology, the description thereof will be omitted. The hose pipe 11 is to show discharge of the coolant from a broken portion when a loss-of-coolant accident (LOCA) occurs.

One end of the hose pipe 11 is directed to an inner side of the containment vessel and the other end is connected with a water supply device (not shown) and a water container. The hose pipe 11 is moved to a place in the containment vessel, in which the broken accident is occurred.

An upper end of the containment vessel is opened so as to supply water through the horse pipe 11, and side and lower surfaces thereof are formed of a transparent material so as to facilely observe an inner side thereof. The containment vessel may be formed by miniaturizing a containment vessel of an actual nuclear reactor at a desired rate, and a core and the other internal structure 13 in the containment vessel may be also formed by miniaturizing them of the actual nuclear reactor.

Particularly, since the lower surface 17 of the containment vessel is formed of a transparent material so as to observe the inner side thereof, it is facile to observe the movement of the debris upon the LOCA and also to measure a flow rate thereof. The side surface 14 of the containment vessel is also formed of a transparent so as to observe the inner side thereof.

A water container part 15 is formed at a lower side of the lower surface 17 of the containment vessel. A moving means such as wheels (not shown) is provided on a lower surface of the water container part 15 so that the water container part 15 can be located at a place corresponding to the water container formed in the actual containment vessel, thereby reflecting a design of the actual nuclear reactor.

For convenience of explanation, an end of the water container part 15 is shown to be spaced apart from the containment vessel 12, but the water container part 15 is closely contacted with a lower portion of the containment vessel so that the coolant passing the lower side of the containment vessel is discharged through the water container part.

Further, one end of the water container part may be connected with an end of the horse pipe 11. That is, the coolant passing the bottom of the containment vessel passes the water container and then discharged again to the hose pipe 11. In other words, when the broken accident is occurred, it is possible to observe movement of the debris during the recirculation process of the coolant and thus to analyze the problems which are occurred at the recirculation process of the coolant.

A measuring device is provided at a lower side of the testing apparatus. The measuring device functions to observe the movement of the debris in the containment vessel. Further, the measuring device is movably disposed in order to observe the inner side of the containment everywhere. That is, the measuring device measures a moving speed of the debris at a certain place.

In the prior art, hydrodynamic analysis was needed to estimate an influence of a structure. In this case, only a value was calculated at a certain place. When manufacturing the testing apparatus, a ball or other floating matter was used to measure a speed of fluid by making a video thereof. However, in the present invention using a laser beam, when the debris are passed, an interference phenomenon is occurred at a surface of a detector due to dispersion of light, and the speed of fluid can be directly measured by obtaining a frequency with respect to the speed using Doppler Effect.

Further, according to the present invention, when a position of the pipe is changed, it is possible to intuitively recognize the movement and passage of the debris by generally allowing the visualization of them.

Particularly, since it is possible to change positions of the hose pipe and the water container part and also to change a position of the internal structure in the containment vessel, the present invention can be applied to any type of containment vessels.

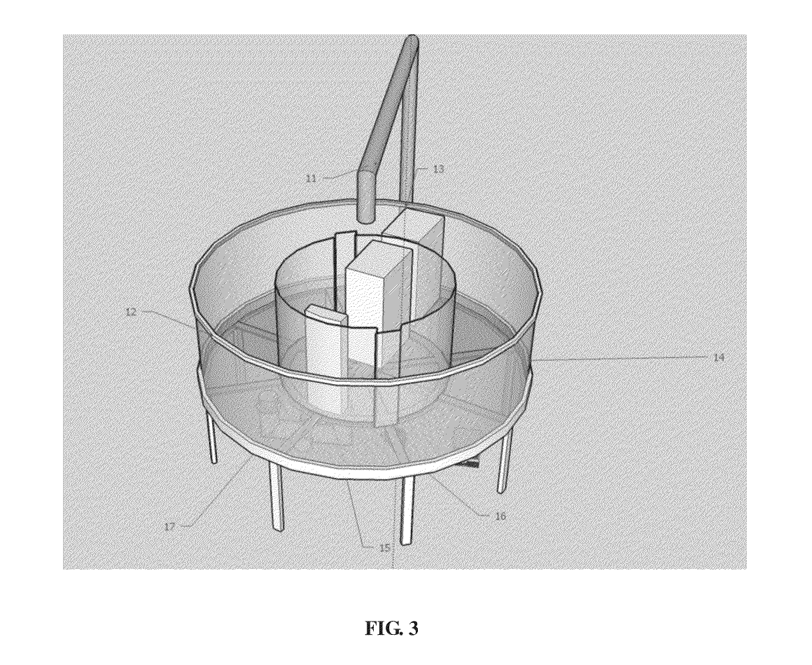

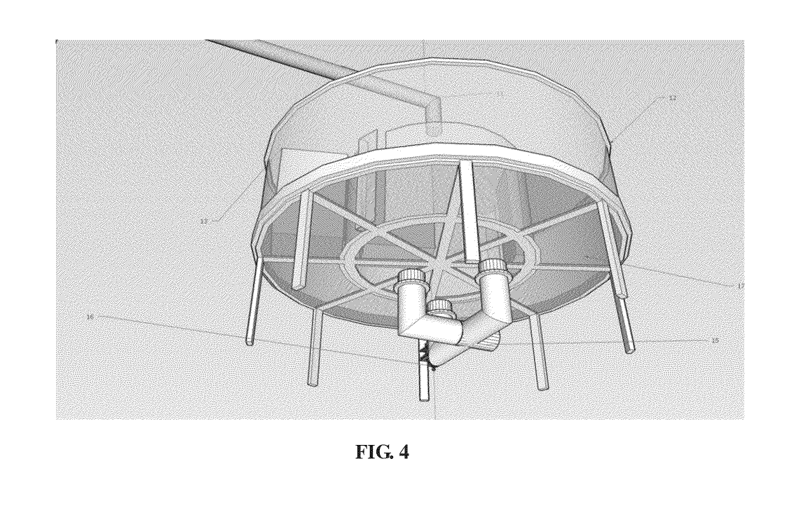

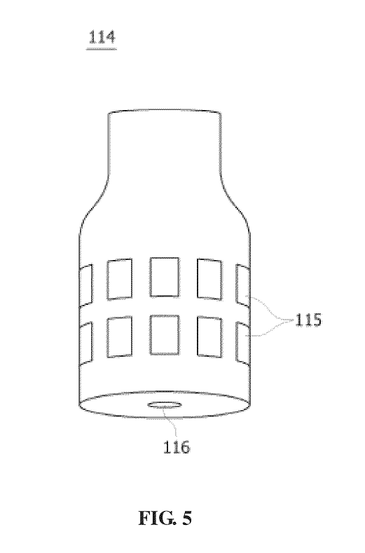

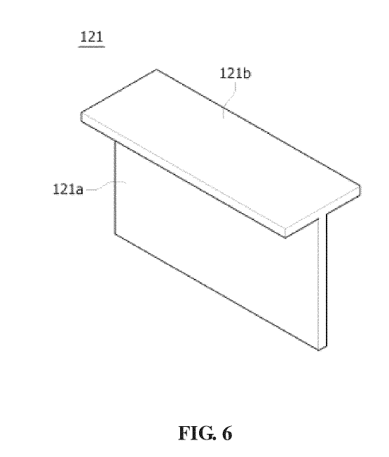

FIG. 3 shows the testing apparatus when viewing from a lower side thereof. Since the measuring device is disposed at the lower side of the testing apparatus, it is possible to measure a flow rate and an accumulated degree of the debris at a desired place. Therefore, the containment vessel 12 is disposed to be spaced apart from the ground in a desired distance. The water container part is also movable by the moving means.

Further, the present invention may additionally include a circulation heating heater for heating the fluid, a flow meter for measuring a flow rate of the fluid, a sensor for sensing a change in temperature and pressure of the fluid.

Further, in order to embody an actual accident, the fluid injected though the hose pipe has temperature and pressure which are the same as the temperature and pressure upon an actual accident, and also the chemical and non-chemical debris which are the same as them upon the actual accident can be injected into the fluid. To this end, the hose pipe may further include a debris injecting device.

Further, in order to embody the case that the head loss is generated, the flow rate of the fluid may be changed.

FIG. 4 shows the testing apparatus including a separate measuring device and a displaying device. According to the testing apparatus of the present invention, since the upper side of the testing apparatus is opened and the side and lower surfaces thereof are formed of the transparent material, it is possible to simultaneously perform the measurement in all directions or in only one direction.

The measuring device may further include a transmittance measuring device for measuring a transmittance of light. When light is radiated from one of the upper and lower side of the containment vessel or from both of them, the transmittance measuring device calculates a transmitted and reflected light amount and thus calculates a degree of the debris accumulated in the containment vessel. The transmittance measuring device may be disposed independently. Therefore, in the present invention, it is possible to actually measure the accumulated degree of the debris. In addition, in order to compensate light refraction according to materials of the fluid and the containment vessel, a refraction compensating part having separate fluid for compensating the light refraction is further included at the upper or lower surface thereof so as to compensate an error of the transmittance according to the light refraction.

According to the test apparatus of the present invention, it is possible to provide the visible data about the LOCA in the nuclear reactor.

While the present invention has been described with respect to the specific embodiments, it will be apparent to those skilled in the art that various changes and modifications may be made without departing from the spirit and scope of the invention as defined in the following claims.

What is claimed is:

1. An apparatus for testing a loss-of-coolant accident using a model of a nuclear containment building, comprising:
a containment vessel of which an upper surface is opened and side and lower surfaces are transparent;
an internal structure which is disposed in the containment vessel;
a hose pipe which is disposed at an upper side of the containment vessel; and
a measuring device which is disposed at the lower surface of the containment vessel so as to monitor movement of fluid and debris in the containment vessel.

2. The apparatus of claim 1, wherein a water container part is disposed at the lower surface of the containment vessel and connected with the hose pipe.

3. The apparatus of claim 2, wherein the hose pipe is movable in all directions.

4. The apparatus of claim 3, wherein the hose pipe further comprises a heater for heating injected fluid, and a debris storing part for injecting non-chemical and chemical debris generated upon an actual accident.

5. The apparatus of claim 1, further comprising a transmittance measuring device which calculates a transmittance of light and thus calculates an accumulated degree of the debris.
